(19) United States
(12) Patent Application Publication
(10) Pub. No.: US 2014/0114974 A1
(43) Pub. Date: Apr. 24, 2014

(54) CO-CLUSTERING APPARATUS, CO-CLUSTERING METHOD, RECORDING MEDIUM, AND INTEGRATED CIRCUIT

(71) Applicant: Panasonic Corporation, Osaka (JP)

(72) Inventor: Iku OHAMA, Osaka (JP)

(73) Assignee: Panasonic Corporation, Osaka (JP)

(21) Appl. No.: 14/054,890

(22) Filed: Oct. 16, 2013

(30) Foreign Application Priority Data
Oct. 18, 2012 (JP) 2012-231218

(51) Int. Cl. G06F 17/30

(52) U.S. Cl. CPC G06F 17/30598
USPC 707/737

(57) ABSTRACT

A co-clustering apparatus that performs co-clustering processing on relational data to divide the relational data into cluster blocks, the apparatus including: a distribution tendency generating unit that generates a distribution tendency of statistic amounts of the cluster blocks in the entire relational data, each of the statistic amounts indicating a tendency of relations generated in the corresponding cluster block; a calculate calculating unit that calculates an importance degree for each of the cluster blocks based on the statistic amount of the cluster block and the distribution tendency generated by the distribution tendency generating unit, using a calculation method for changing a result of calculation of the importance degree according to the distribution tendency; and an output unit that outputs at least one piece of information indicating the cluster blocks and information indicating the importance degree calculated for the at least one of information by the calculating unit.

### CROSS REFERENCE TO RELATED APPLICATION

The present application is based on and Claims priority of Japanese Patent Application No. 2012-231218 filed on Oct. 18, 2012. The entire disclosure of the above-identified application, including the specification, drawings and Claims is incorporated herein by reference in its entirety.

### FIELD

One or more exemplary embodiments disclosed herein relate generally to a co-clustering apparatus, co-clustering method, recording medium, and integrated circuit that perform co-clustering on relational data expressible in a format of a matrix or a tensor having at least three dimensions.

### BACKGROUND

One of effective methods for analyzing relational data is clustering. When the relational data includes sets of objects (hereinafter referred to as domains), clustering can be performed on the respective domains simultaneously. The simultaneous clustering on the respective domains is called co-clustering in particular, which has been studied in various ways.

Known examples of the conventional co-clustering technique include a technique described in Non-Patent Literature 1. The Infinite Relational Model (hereinafter referred to as the IRM) proposed in Non-Patent Literature 1 is a non-parametric Bayesian model that represents a generative process of the relational data. The IRM can perform co-clustering on the relational data expressible in a format of a matrix or a tensor having at least three dimensions based on relational similarities.

Known examples of the conventional co-clustering technique also include a technique described in Patent Literature 1. According to Patent Literature 1, co-clustering based on relational similarities is performed on the relational data, and the input relational data is divided into cluster blocks. In division of the relational data, the statistic amount (correlation strength) is calculated in each of the cluster blocks. The calculated statistic amount is considered as the importance degree of the cluster block, and the cluster blocks are sorted in descending order of the importance degree and displayed to express the order of importance degree.

### CITATION LIST

### Patent Literature

[Patent Literature 1]Japanese Patent No. 4690199

### Non Patent Literature

[Non-Patent Literature 1]C. Kemp, J. Tenenbaum, T. Griffiths, T. Yamada and U. Naonori: “Learning systems of concepts with an infinite relational model,” in Proceedings of the 21st national conference on Artificial intelligence—Volume 1, ser. AAAI'06. AAAI Press, 2006, pp. 381-388.

### SUMMARY

### Technical Problem

Unfortunately, the conventional co-clustering technique cannot specify the importance degree of the cluster block properly.

To solve this problem, one non-limiting and exemplary embodiment provides a co-clustering apparatus that can specify the importance degree of the cluster block more properly.

### Solution to Problem

In one general aspect, the techniques disclosed here feature a co-clustering apparatus that performs co-clustering processing on relational data expressible in a format of a matrix or a tensor having at least three dimensions to divide the relational data into cluster blocks, the co-clustering apparatus including: a distribution tendency generating unit configured to generate a distribution tendency of statistic amounts of the cluster blocks in the entire relational data, each of the statistic amounts indicating a tendency of relations generated in the corresponding cluster block; a calculating unit configured to calculate an importance degree for each of the cluster blocks based on the statistic amount of the cluster block and the distribution tendency generated by the distribution tendency generating unit, using a calculation method for changing a result of calculation of the importance degree according to the distribution tendency; and an output unit configured to output information indicating at least one of the cluster blocks and information indicating the importance degree calculated for the at least one of the cluster blocks by the calculating unit.

These general or specific aspects may be implemented using a system, a method, an integrated circuit, a computer program, or a computer-readable recording medium such as a CD-ROM, or any combination of systems, methods, integrated circuits, computer programs, and recording media.

Additional benefits and advantages of the disclosed embodiments will be apparent from the Specification and Drawings. The benefits and/or advantages may be individually obtained by the various embodiments and features of the Specification and Drawings, which need not all be provided in order to obtain one or more of such benefits and/or advantages.

### Advantageous Effects

The co-clustering apparatus according to one or more exemplary embodiments or features disclosed herein can specify the importance degree of the cluster block more properly.

### BRIEF DESCRIPTION OF DRAWINGS

These and other advantages and features will become apparent from the following description thereof taken in conjunction with the accompanying Drawings, by way of non-limiting examples of embodiments of the present disclosure. In the Drawings:

FIG. 1 is a block diagram showing an example of a configuration of a co-clustering apparatus according to Embodiment 1.

FIG. 2 is a diagram showing an example of relational data according to Embodiment 1.

FIG. 3 is a diagram showing another example of the relational data according to Embodiment 1.

FIG. 4 is a diagram for describing co-clustering according to Embodiment 1.

FIG. 5 is a flowchart showing an example of operation of the co-clustering apparatus according to Embodiment 1.

FIG. 6 is a diagram showing an example of processing performed by the co-clustering apparatus according to Embodiment 1.

FIG. 7 is a block diagram showing another example of a configuration of the co-clustering apparatus according to Embodiment 1.

FIG. 8 is a block diagram showing an example of a co-clustering apparatus according to Embodiment 2.

### DESCRIPTION OF EMBODIMENTS

### Underlying Knowledge Forming Basis of the Present Disclosure

In the relation to the method for analyzing relational data disclosed in the Background section, the present inventor has found the following problem.

Use of the Internet is vital to various situations in everyday life and business these days. Thus, relationships between individuals and other individuals (or things) such as “Who bought what?” and “Who knows who” are inevitably formed in the social activities of the individuals, and accumulated as electronic information. To analyze the information indicating these relationships (hereinafter referred to as relational data), to know latent tendencies of individual needs and preferences becomes increasingly important.

One of effective methods for analyzing relational data is clustering. The clustering of the relational data forms a group of similar objects, assuming that an object that forms a relation, that is, a person or a thing (hereinafter referred to as an object) depends on the cluster to which the object belongs, and forms a relation with another object based on a characteristic tendency.

The relational data typically includes sets of objects (hereinafter referred to as domains), that is, a set of persons and a set of commodities in a purchase history. Clustering can be performed on the respective domains simultaneously. The simultaneous clustering on the respective domains is called co-clustering in particular, which has been studied in various ways.

Known examples of the conventional co-clustering technique include a technique described in Non-Patent Literature 1. The Infinite Relational Model (hereinafter referred to as the IRM) proposed in Non-Patent Literature 1 is a non-parametric Bayesian model that represents a generative process of the relational data. The IRM can perform co-clustering on the relational data expressible in a format of a matrix or a tensor having at least three dimensions, based on relational similarities. When the relational data is co-clustered, each domain is cluster divided into clusters. The clusters are divided into block-like regions (hereinafter referred to as cluster blocks) for the respective combinations of the clusters in one domain with those in another domain. Each of the cluster blocks can be interpreted as a unit having similarities in easiness (difficulty) to form a relation. For example, when persons buy commodities, co-clustering is performed on the relational data indicating the purchase histories of the commodities bought by the persons, and the respective cluster blocks thus obtained are examined. Thereby, a tendency can be found between a cluster of a specific person and a cluster of a specific item, for example, the person is or is not likely to buy the item. Unfortunately, in such a method, all the cluster blocks need to be examined to find which cluster block is important. For this reason, it is difficult to determine which cluster block is noteworthy and important when the number of cluster blocks is extremely large.

Known examples of the technique to solve the problem include a technique disclosed in Patent Literature 1. In the technique disclosed in Patent Literature 1, co-clustering based on relational similarities is performed on the relational data, and the relational data is divided into cluster blocks. In division of the relational data, a correlation strength is calculated as the statistic amount for each of the cluster blocks. The calculated correlation strength is considered as the importance degree of the cluster block, and the cluster blocks are sorted and displayed to express the order of the importance degree of the cluster block.

However, considering the calculated correlation strength as the importance degree may not be appropriate, depending on the properties of the input relational data.

For example, when the correlation strength calculated wherein the entire relational data is considered as one cluster block has a high value, a cluster block having a low correlation strength may be the cluster block having a high importance degree. The reason is that in such a case, the cluster block having a property different from that of the entire relational data, that is, the cluster block having a low correlation strength is determined as a noteworthy and important cluster block.

When the correlation strength calculated wherein the entire relational data is considered as one cluster block has a low value, a cluster block having a high correlation strength may be the cluster block having a high importance degree. The reason is that in such a case, the cluster block having a property different from that of the entire relational data, that is, the cluster block having a high correlation strength is determined as a noteworthy and important cluster block.

In the two cases above, it is difficult to specify the importance degree of the cluster block by the conventional technique. In such circumstances, the importance degrees of the respective cluster blocks change according to the value of the correlation strength of the entire relational data. For this reason, the importance degree of the cluster block cannot be specified only by calculating the correlation strengths of the respective cluster blocks.

Namely, only calculation of the statistic amounts of the cluster blocks as in the conventional technique lead to difficulties in specifying the importance degree of the cluster block in the circumstances in which the importance degrees of the cluster blocks change according to the tendency of distribution in the entire relational data.

Then, one non-limiting and exemplary embodiment provides a co-clustering apparatus that can specify an importance degree of a cluster block.

Namely, one non-limiting and exemplary embodiment provides a co-clustering apparatus that can specify an importance degree of a cluster block in relational data expressed in a format of a matrix or a tensor having at least three dimensions in consideration of the tendency of distribution in the entire relational data.

To solve the problem above, according to an exemplary embodiment disclosed herein, a co-clustering apparatus includes a co-clustering apparatus that performs co-clustering processing on relational data expressible in a format of a matrix or a tensor having at least three dimensions to divide the relational data into cluster blocks, the co-clustering apparatus including: a distribution tendency generating unit configured to generate a distribution tendency of statistic amounts of the cluster blocks in the entire relational data, each of the statistic amounts indicating a tendency of relations generated in the corresponding cluster block; a calculating unit configured to calculate an importance degree for each of the cluster blocks based on the statistic amount of the cluster block and the distribution tendency generated by the distribution tendency generating unit, using a calculation method for changing a result of calculation of the importance degree according to the distribution tendency; and an output unit configured to output information indicating at least one of the cluster blocks and information indicating the Importance degree calculated for the at least one of the cluster blocks by the calculating unit.

Thereby, the co-clustering apparatus outputs the importance degrees of the cluster blocks in consideration of the distribution tendency of the statistic amounts of the cluster blocks when the co-clustering processing is performed on the relational data expressed in a format of a matrix or a tensor having at least three dimensions. The importance degrees of the cluster blocks output here are results obtained in consideration of the statistic amount of the entire relational data and the statistic amounts of the cluster blocks. Accordingly, a different importance degree will be output if the cluster blocks each have the same entities and the entire relational data has a different statistic amount. Namely, use of the distribution tendency enables calculation of the importance degrees of the cluster blocks in consideration of the tendency of the entire input relational data. Thus, the importance degrees of the cluster blocks according to the property of the relational data can be specified.

For example, the distribution tendency generating unit is configured to generate a statistic amount of the entire relational data as the distribution tendency.

Thereby, each of the statistic amounts of the cluster blocks obtained by performing co-clustering can be compared to the statistic amount of the entire relational data before performing co-clustering. Each of the cluster blocks can be evaluated how rare the cluster block is in the input relational data, and the evaluation can be reflected in the importance degree.

For example, the calculating unit is configured to calculate the importance degree for each of the cluster blocks to output a greater importance degree as a distance between a value in the cluster block indicated by the distribution tendency and the statistic amount of the cluster block is larger.

Thereby, each of the statistic amounts of the cluster blocks obtained by performing co-clustering can be compared to the statistic amount of the entire relational data before performing co-clustering, and it can be determined that a cluster block having a greater difference has a relatively high importance degree.

For example, the calculating unit is configured to calculate the importance degree for each of the cluster blocks using the distribution tendency, the statistic amount of the cluster block, and a size of the cluster block.

Thereby, in addition to the comparison of the statistic amounts of the cluster blocks to the statistic amount when the entire relational data is considered as one cluster block, the importance degree can be calculated in consideration of the size of the cluster block.

For example, the distribution tendency generating unit is configured to perform clustering processing on statistic amount data having the statistic amounts of the cluster blocks as entities to divide the statistic amount data into clusters, and generate information on the clusters as the distribution tendency, the clusters being obtained by the division of the statistic amount data

Thereby, a cluster block having a high importance degree can be specified in consideration of the distribution tendency of the statistic amounts of the cluster blocks even in the relational data having a complicated distribution tendency of the statistic amounts of the cluster blocks.

For example, the calculating unit is configured to calculate the importance degree for each of the clusters to output a greater importance degree for the cluster block included as an entity in the cluster as the number of entities within the cluster is smaller.

Thereby, in the relational data having a complicated distribution tendency of the statistic amounts of the cluster block, each of the cluster blocks obtained by the co-clustering is evaluated how rare the cluster block is in the relational data to which the cluster block is input, and the evaluation can be reflected in the importance degree.

For example, the calculating unit is configured to calculate the importance degree for each of the cluster blocks included as entities in the cluster, based on the number of entities within the cluster and sizes of one or more of the cluster blocks corresponding to entities of the clusters for each of the clusters.

Thereby, the Importance degree can be calculated in consideration of the size of the cluster block in addition to the number of cluster blocks that belong and the statistic amounts of the cluster blocks.

These general and specific aspects can be implemented not only as the co-clustering apparatus, but also as a method including steps corresponding to the processing units that form the co-clustering apparatus. Alternatively, these general and specific aspects may be implemented as a program causing a computer to execute these steps. Furthermore, these general and specific aspects may be implemented as a recording medium on which the program is recorded such as computer-readable Compact Disc-Read Only Memory (CD-ROM), information, data, or signals indicating the program. The program, information, data, and signals may be distributed through a communication network such as the Internet.

Components that form the apparatus may be partially or entirely composed of a single Large Scale Integration (LSI). The system LSI is an ultra-multifunctional LSI manufactured by integrating a plurality of constituent units on a single chip, and specifically a computer system including a microprocessor, a ROM, and a Random Access Memory (RAM).

These general and specific aspects may be implemented using a system, a method, an integrated circuit, a computer program, or a computer-readable recording medium such as a CD-ROM, or any combination of systems, methods, integrated circuits, computer programs, or computer-readable recording media.

Hereinafter, certain exemplary embodiments are described in greater detail with reference to the drawings.

Each of the exemplary embodiments described below shows a general or specific example. The numerical values, shapes, materials, structural elements, the arrangement and connection of the structural elements, steps, the processing order of the steps etc. shown in the following exemplary embodiments are mere examples, and therefore do not limit the scope of the appended Claims and their equivalents. Therefore, among the structural elements in the following exemplary embodiments, structural elements not recited in any one of the independent Claims are described as arbitrary structural elements.

### Embodiment 1

First, an outline of a co-clustering apparatus according to Embodiment 1 will be described. The co-clustering apparatus according to Embodiment 1 is a co-clustering apparatus that performs co-clustering processing on relational data expressible in a format of a matrix or a tensor having at least three dimensions to divide the relational data into cluster blocks. The co-clustering apparatus includes a distribution tendency generating unit that generates a distribution tendency of statistic amounts of the cluster blocks in the entire relational data, each of the statistic amounts indicating a tendency of relations generated in the corresponding cluster block; a calculating unit that calculates an importance degree for each of the cluster blocks based on the statistic amount of the cluster block and the distribution tendency generated by the distribution tendency generating unit, using a calculation method for changing a result of calculation of the importance degree according to the distribution tendency; and an output unit that outputs information indicating at least one of the cluster blocks and information indicating the importance degree calculated for the at least one of the cluster blocks by the calculating unit.

Thereby, the co-clustering apparatus outputs the importance degrees of the cluster blocks in consideration of the distribution tendency of the statistic amounts of the cluster blocks when the co-clustering processing is performed on the relational data expressed in a format of a matrix or a tensor having at least three dimensions. The importance degrees of the cluster block outputs here are results obtained in consideration of the statistic amount of the entire relational data and the statistic amounts of the cluster blocks. Accordingly, a different importance degree will be output if the cluster blocks each have the same entitles and the entire relational data has a different statistic amount. Namely, use of the distribution tendency enables calculation of the importance degrees of the cluster blocks in consideration of the distribution tendency of the entire input relational data. Thus, the importance degrees of the cluster blocks can be specified according to the property of the relational data.

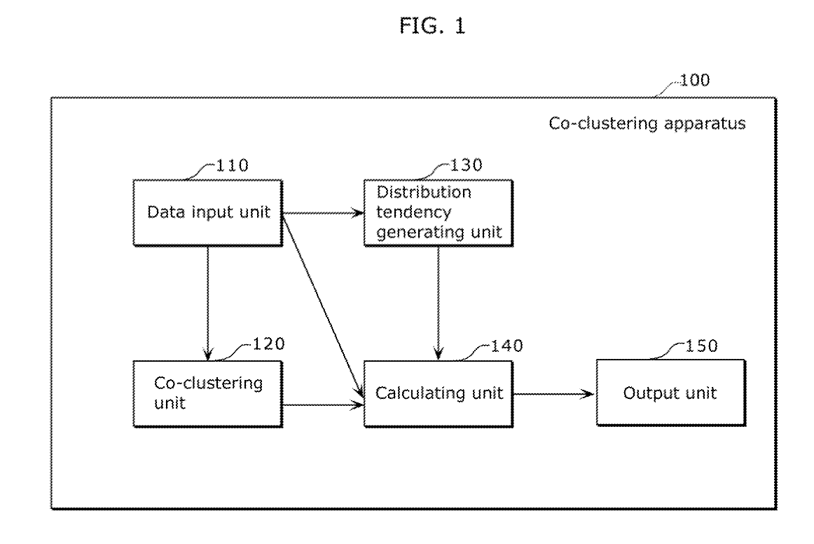

Hereinafter, first, the configuration of the co-clustering apparatus according to the present embodiment will be described. FIG. 1 is a block diagram showing an example of the configuration of the co-clustering apparatus 100 according to the present embodiment. As shown in FIG. 1, the co-clustering apparatus 100 according to the present embodiment includes a data input unit 110, a co-clustering unit 120, a distribution tendency generating unit 130, a calculating unit 140, and an output unit 150.

The data input unit 110 inputs the relational data expressed (expressible) in a format of a matrix or a tensor having at least three dimensions into the co-clustering apparatus 100. The relational data input via the data input unit 110 may be read from a magnetic disk device such as hard disk drive (HDD) or a memory card, or may be input via a user interface. Alternatively, the data retrieved and collected by a user from the data on the Internet may be input as the relational data.

Here, the definition of the relational data will be described.

The relational data includes the domain information on one or more domains and inter-object relation information. The domain information includes the information for specifying a plurality of objects that form the domain. For example, consider an example of the relational data indicating the purchase history in the Internet shopping service. In this case, the relational data includes two domains “T¹: user set” and “T²: item set.” The user set represents a universal set of users to whom the Internet shopping service is available. The item set represents a universal set of items that the users can buy through the Internet shopping service. At this time, the domain information on the user set means the information for specifying the respective users included in the user set. The domain information on the item set means the information for specifying the respective items included in the item set. The inter-object relation information is the information indicating the relation between objects. For example, when the relational data indicates the purchase history, the inter-object relation information is the information for enabling specification of the binary relation “buy” or “not buy” in a pair of any user included in the “user set” and any item included in the “item set.” The format of the relational data in the example of the purchase history is expressed below:

R:T¹×T²→{0,1} [Math. 1]

The expression means that the relational data R includes the domain information T¹ and the domain information T², and the inter-object relation information defines a binary relation {0,1} between the object included in T¹ and the object included in T². In the example of the purchase history described above, T¹ represents a set of users, T² represents a set of items, and the binary value {0,1}represents “buy” or “not buy.” When T¹ is composed of the number of N¹ of users and T² is composed of the number of N² of items, the relational data can be illustrated in a format of a matrix with N¹ rows and N² columns.

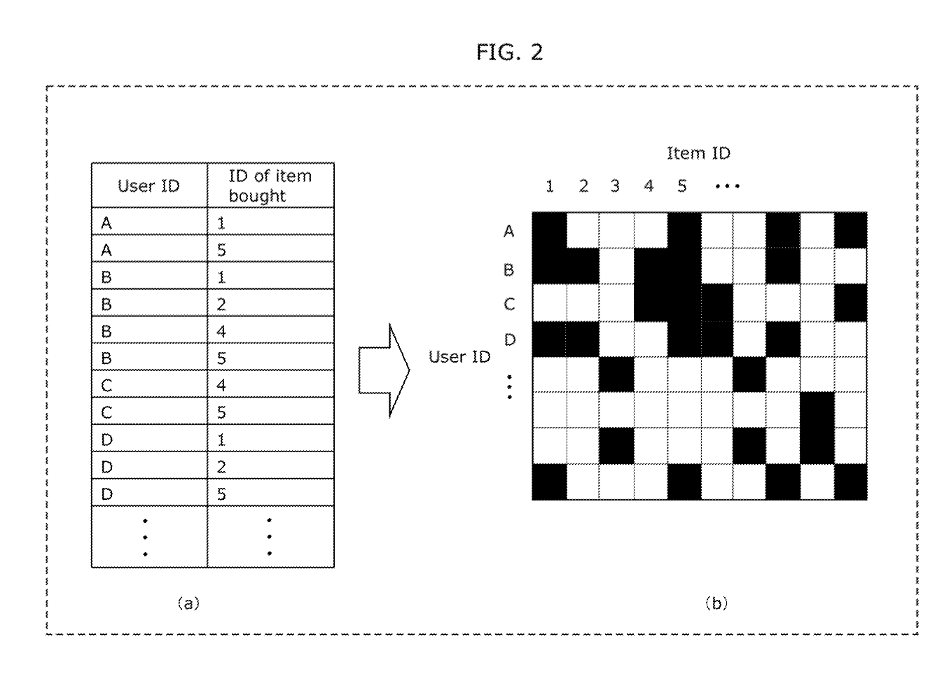

FIG. 2 is a diagram showing an example of the relational data according to the present embodiment. The relational data shown in FIG. 2 is an example of the relational data in a format of a matrix with N¹ rows and N² columns. (a) of FIG. 2 is a table showing a correspondence between a user and an item bought by the user. (b) of FIG. 2 is a diagram showing the relational data expressed in white and black with T¹ (user set) on the ordinate and T² (item set) on the abscissa.

Here, i is defined as an index of an object included in T¹, and j is defined as an index of an object included in T². Then, the entity R(i,j) in row i and column j represents whether an i-th user:

Oᵢ¹ [Math. 2]

bought a j-th item:

Oⱼ² [Math. 3]

or not.
In (b) of FIG. 2, the color of white represents “not buy” (0), and the color of black represents “buy” (1).

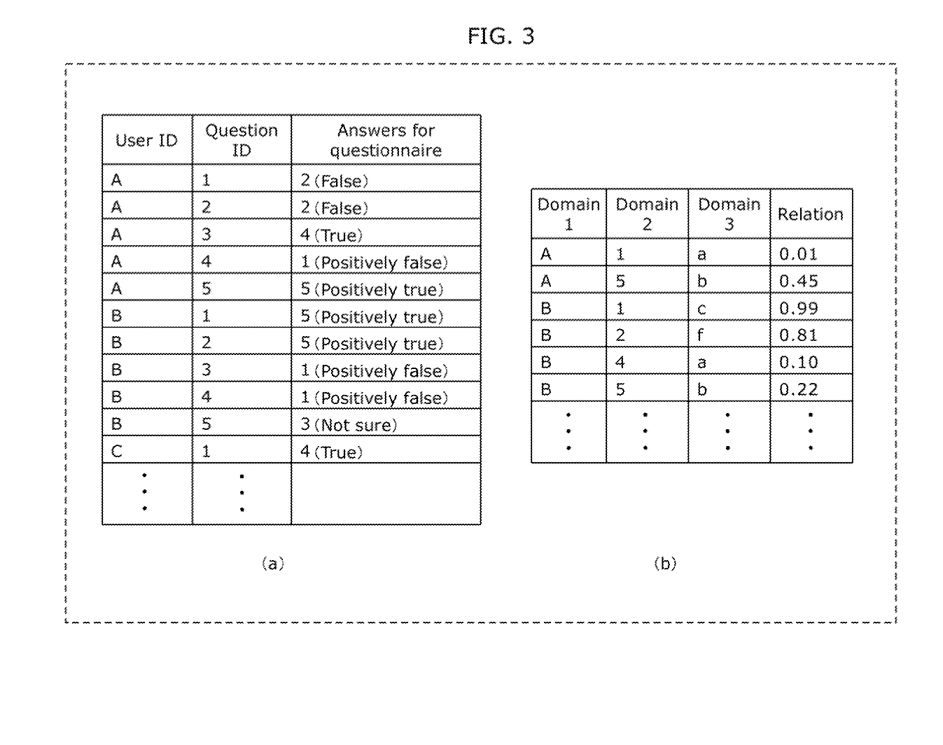

The relational data has variations. FIG. 3 is a diagram showing another example of the relational data according to the present embodiment.

(a) of FIG. 3 is a diagram showing results of a questionnaire having a plurality of questions wherein a user answers each question on a scale of 1 to 5. This is an example of the relational data having several relations (several answers for the question) between the user set and the question set.

(b) of FIG. 3 is an example of the relational data having a multivalued relation between three domains.

For example, the friend relationship on a social network service (SNS) is the relational data represented by:

R:T¹×T¹→{0,1}. [Math. 4]

When the relation is not binary but multivalued,

R:T¹×T²→{1,2,3,4,5}. [Math. 5]

For continuous values,

R:T¹×T²→[−10.0,+10.0] [Math. 6]

can be thought, for example. Furthermore, the relational data representing relations among three or more domains:

R:T¹×T²×T³→{0,1} [Math. 7]

can be thought, for example. In this case, the relational data can be considered as not a matrix but a tensor that is a generalized concept of the matrix.

All the variations of the relational data as above are included in the scope of the relational data in the co-clustering apparatus according to Embodiment 1. In the description below, for convenience, the relational data representing a binary relation between two domains:

R:T¹×T²→{0,1} [Math. 8]

will be described as a specific example, but the relational data will not be limited to this.

As above, the definition of the relational data has been described.

The co-clustering unit 120 performs co-clustering on relational data R as an input, and outputs cluster blocks (or information indicating cluster blocks) as a result of co-clustering. The co-clustering is a type of clustering, and means that the domains included in the relational data are simultaneously clustered. The result of clustering includes at least the information for specifying the clusters to which the objects included in the domains belong. Specifically, for the relational data composed of two domains:

R:T¹×T²→{0,1}, [Math. 9]

based on relational similarities, the co-clustering apparatus 100 determines the cluster assignment of T¹:

z¹={zᵢ¹}ᵢ₌₁^{N}^{¹}εC¹ [Math. 10]

and the cluster assignment of T²:

z²={zⱼ²}ⱼ₌₁^{N}^{²}εC² [Math. 11]

for the relational data R, and outputs z¹ and z² as results of clustering. Note that

C¹={1,2, . . . } [Math. 12]

is a set of categories of the clusters for T¹, and

C²={1,2, . . . } [Math. 13]

is a set of categories of the clusters for T².

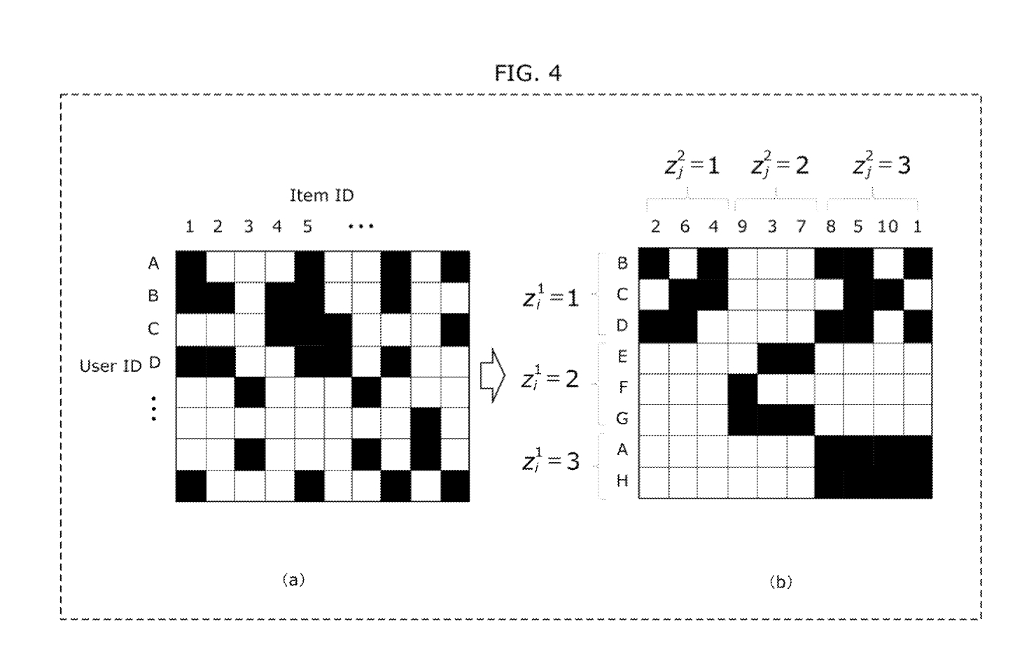

Examples of an algorithm that actually implements co-clustering include various algorithms. Here, a procedure for implementing co-clustering using the IRM cited as Non-Patent Literature 1 will be specifically described. The co-clustering to be described here converts the relational data shown in (a) of FIG. 4 into the data as a result of the co-clustering as shown in (b) of FIG. 4.

The IRM proposed by Kemp et al. is a probability model that expresses the generative process of the relational data. The generative model wherein the relational data:

R:T¹×T²→{0,1} [Math. 14]

is given by (Expression 1-1) to (Expression 1-4):

[Math. 15]

zᵢ¹|γ˜CRP(γ)(iεT¹). (Expression 1-1)

zⱼ²|γ˜CRP(γ)(jεT²). (Expression 1-2)

η(k,l)|β˜Beta(β,β)(kεC¹,lεC²) (Expression 1-3)

R(i,j)|z¹,z²,η˜Bernoulli(η(zᵢ¹,zⱼ²))(iεT¹,jεT²) (Expression 1-4).

Here, CRP(•) means a Chinese Restaurant Process, Beta(•,•) means Beta distribution, and Bernoulli(•,•) means Bernoulli distribution. γ represents a parameter for the Chinese Restaurant Process, and β represents a parameter for the Beta distribution.

The generative model expressed by (Expression 1-1) to (Expression 1-4) will be briefly described. First, cluster assignments are generated for the respective domains (Expressions 1-1 and 1-2). Next, the probability η(k,l) that a relation is generated in the cluster block is generated for the cluster block (k,l) according to the Beta distribution (Expression 1-3). Finally, a relation R(i,j) that forms the relational data is generated according to the Bernoulli distribution wherein the parameter is η(k,l) specified by a pair of the cluster to which an object i belongs:

zᵢ¹ [Math. 16]

and the cluster to which an object j belongs:

zⱼ². [Math. 17]

In the generative model expressed by (Expression 1-1) to (Expression 1-4), the probability that the relational data R is generated is calculated by (Expression 2):

[Math. 18]

P(R|z¹,z²,η)P(η|β)P(z¹|γ)P(z²|γ) (Expression 2)

Here, the Beta distribution is a natural conjugate prior distribution of the Bernoulli distribution. Then, (Expression 2) can be written as a format η integrated out shown in (Expression 3):

[Math. 19]

P(R|z¹,z²,β)P(z¹|γ)P(z²|γ)=P(z¹|γ)P(z²|γ)∫P(R|z¹,z²,η)P(η|β)dη (Expression 3).

When the cluster assignments z¹ and z² are obtained, the probability that the relational data R is generated can be determined by calculating (Expression 3). Namely, the cluster assignments z¹ and z² are obtained as the output from the co-clustering unit 120 by solving the optimization problem:

$$\begin{matrix} [ Math . 20 ] & \\ {argmax}_{{z}^{1} , {z}^{2 }} P ( {z}^{1} , {z}^{2} \vert R , β , γ ) = {argmax}_{{z}^{1} , {z}^{2 }} P ( R \vert {z}^{1} , {z}^{2} , β ) P ( {z}^{1} \vert γ ) P ( {z}^{2} \vert γ ) . & ( Expression 4 )\end{matrix}$$

To solve (Expression 4) actually, various methods have been proposed. Here, as one example, an estimation method using Gibbs sampling will be described. The Gibbs sampling is one of methods called Markov Chain Monte Carlo methods. This method can start search for the probability distribution space from a proper initial value, and estimate a place having a high probability density. Namely, for (Expression 4), by use of the Gibbs sampling, wherein z¹ and z² are variables, the probability distribution space:

P(z¹,z²|R,β,γ) [Math. 21]

can be searched, and the estimation values of z¹ and z² when the likelihood is the maximum can be obtained. Here, logical explanation will be omitted and only the conclusion will be described. The procedure of the Gibbs sampling to solve the problem expressed by (Expression 4) is given as follows.
(Procedure 1) The initial values of z¹ and z² are determined properly.
(Procedure 2) i=1, 2, . . . , N¹ is subjected to the following processing:

### (Procedure 2-1)

By the probability according to:

P(zᵢ¹=k*|z₋ᵢ¹,z²,R,β,γ), [Math. 22]

the value of:

zᵢ¹ [Math. 23]

is updated.
(Procedure 3) j=1, 2, . . . , N² is subjected to the following processing:

### (Procedure 3-1)

By the probability according to:

P(zⱼ²=l*|z¹,z₋ⱼ²,R,β,γ), [Math. 24]

the value of:

zⱼ² [Math. 25]

is updated.

### (Procedure 4)

The value of:

P(z¹,z²|R,β,γ) [Math. 26]

is calculated, and if the value is not converged, the processing in (Procedure 2) is executed. When the value is converged, the procedure is terminated. Note that

$$\begin{matrix} [ Math . 27 ] & \\ P ( {z}_{i}^{1} = {k}^{*} \vert {z}_{- i}^{1} , {z}^{2} , R , β , γ ) ∝ \{ \begin{matrix}\frac{{m}_{- l , {k}^{′}}^{1}}{{N}^{1} - 1 + γ} {\prod }_{l = 1}^{L} \frac{B ( \begin{matrix}{m}_{+ i} ( {k}^{*} , l ) + β , \\ {\overline{m}}_{+ i} ( {k}^{*} , l ) + β\end{matrix} )}{B ( \begin{matrix}{m}_{- i} ( {k}^{*} , l ) + β , \\ {\overline{m}}_{- i} ( {k}^{*} , l ) + β\end{matrix} )} & {m}_{- i , {k}^{′}}^{1} > 0 \\ \frac{γ}{{N}^{- 1} + 1 + γ} {\prod }_{l = 1}^{L} \frac{B ( \begin{matrix}{m}_{+ i} ( {k}^{*} , l ) + β , \\ {\overline{m}}_{+ i} ( {k}^{*} , l ) + β\end{matrix} )}{B ( β , β )} & {m}_{- i , {k}^{′}}^{1} = 0 ,\end{matrix} & ( Expression 5 )\end{matrix}$$

wherein

m_{-i,k*}¹ [Math. 28]

is the number of objects assigned to the cluster k* in the domain T¹ at present under the condition in which the i-th object is neglected; L is the number of clusters related to the domain T^{j} at present.

m₋ᵢ(k*,l) [Math. 29]

is the number of links (R(i,j)=1) In the cluster block (k*,l) counted by neglecting row i in the relational data R.

m̅₋₁(k*,l) [Math. 30]

is the number of non-links (R(i,j)=0) counted in the same manner.

m₊ᵢ(k*,l) [Math. 31]

is the number of links counted assuming that the cluster assignment of row i in the relational data R:

zᵢ¹ [Math. 32]

is k*.

m̅₊ᵢ(k*,l) [Math. 33]

is the number of non-links counted in the same manner.

P(zⱼ²=l*|z¹,z₋ⱼ²,R,β,γ) [Math. 34]

can be derived in the same manner, and explanation will be omitted.

According to the procedures above, the co-clustering of the relational data as shown in FIG. 4 is performed. The co-clustering procedure described above is only one of non-limiting examples of co-clustering. According to the relational data R to be input, a generative model for treating three or more domains may be used, or a totally different co-clustering method including at least the information for specifying the clusters to which the objects included in the domains belong may be used. Moreover, use of the Gibbs sampling for estimation of the generative model is only one of non-limiting examples of estimation. Any estimation method for the generative model such as Variational Bayes Inference may be used.

In the cluster blocks generated by performing co-clustering on the input relational data R, the distribution tendency generating unit 130 generates the distribution tendency information on the statistic amounts that characterize the corresponding cluster blocks. Here, the statistic amount that characterizes a cluster block is the information indicating the tendency of the values that the relations included in the cluster block have. For example, a numeric value such as the average or variance of the values that the relations in the cluster block have, or a set of numeric values representing parameters obtained by applying any probability distribution to the relations in the cluster block can be used. The distribution tendency information includes at least the information indicating how the statistic amounts corresponding to the cluster blocks generated by performing co-clustering on the relational data R are dispersed. For example, it is thought that one example of the distribution tendency information is the average value of the respective relations wherein the entire relational data R is considered as one cluster block. For example, examine an example of the binary relational data on two domains:

R:T¹×T²→{0,1}, [Math. 35]

where the entire relational data R is considered as one cluster block, the average value of the respective relations can be calculated by:

$$\begin{matrix}[ Math . 36 ] & \\ {\overline{η}}_{ML}^{ALL} = \frac{{\sum }_{i = 1}^{{N}^{1}} {\sum }_{j = 1}^{{N}^{2}} R ( i , j )}{{N}^{1} \times {N}^{2}} . & ( Expression 6 )\end{matrix}$$

The value means the proportion in which the relation between objects is 1 in the binary relational data. For this reason, when

η̅_{ML}^{ALL} [Math. 37]

is close to 0.0, the relational data R is sparse data in which most of the values of the relations are 0. Accordingly, it indicates that it is highly possibly that the statistic amounts of the cluster blocks generated by performing co-clustering on the relational data R also gather in the vicinity of the value close to 0.0. Meanwhile, when

η̅_{ML}^{ALL} [Math. 38]

is close to 1.0, the relational data R is dense data in which most of the values of the relations are 1. Accordingly, it indicates that it is highly possibly that the statistic amounts of the cluster blocks generated by performing co-clustering on the relational data R also gather in the vicinity of the value close to 1.0. Here, an example in which the average value of the relations is the distribution tendency information has been described, but this is only an example. The distribution tendency information will not be limited to this. The distribution tendency information may be a variance, another statistic amount, or a set of statistic amounts.

The calculating unit 140 uses the relational data R, the results of co-clustering z¹ and z², and the distribution tendency information as the input, and generates the information on the importance degrees of the respective cluster blocks. The importance degree information is a numeric value that indicates how noteworthy the cluster block is, and changes according to at least the distribution tendency information. For example, when the entire relational data R is considered as one cluster block and the distribution tendency information is the average value of the respective relations:

η̅_{ML}^{ALL}, [Math. 39]

from the relational data R and the results of co-clustering z¹ and z², the statistic amount of the cluster block:

η̅_{ML}(k,l) [Math. 40]

is determined. Then, using

η̅_{ML}^{ALL}, [Math. 41]

and

η̅_{ML}(k,l) [Math. 42]

as arguments of the function:

D( η̅_{ML}^{ALL}, η̅_{ML}(k,l)), [Math. 43]

the importance degree of the cluster block (k,l) is calculated. Alternatively, the statistic amount of the cluster block:

η̅_{ML}(k,l) [Math. 44]

may be calculated, for example, as the average value of the relations in the cluster block by:

$$\begin{matrix}[ Math . 45 ] & \\ {\overline{η}}_{ML} ( k , l ) = \frac{m ( k , l )}{m ( k , l ) + \overline{m} ( k , l )} . & ( Expression 7 )\end{matrix}$$

The function D(•,•) is a distance function to return a Euclidean distance. The importance degree I(k,l) of the cluster block (k,l) may be calculated by:

I(k,l)=D( η̅_{ML}^{ALL}, η̅_{ML}(k,l))≡| η̅_{ML}^{ALL}− η̅_{ML}(k,l)|. (Expression 8)

In Embodiment 1, corresponding to the example in which the relational data R is considered as one cluster block and the distribution tendency information is the average value of the relations:

η̅_{ML}^{ALL}, [Math. 47]

the statistic amount of the cluster block:

η̅_{ML}(k,l) [Math. 48]

is the average value of the relations in the cluster block. This is only an example, and the statistic amount will not be limited to this. For example, the statistic amount may be a variance or any other statistic index. In Embodiment 1, the importance degree I(k,l) is defined as the Euclidean distance between:

η̅_{ML}^{ALL}, [Math. 49]

and

η̅_{ML}(k,l) [Math. 50]

This is only an example, and the importance degree I(k,l) will not be limited to this. The importance degree I(k,l) may be a value calculated depending on at least the distribution tendency information and the statistic amount of the cluster block.

The output unit 150 uses the relational data R, the results of co-clustering z¹ and z², and the importance degree information as an input, and outputs the information indicating the importance degree of the cluster block. The information indicating the importance degree of the cluster block refers to the information indicating at least one of the cluster blocks generated by the co-clustering unit 120 and the information indicating the cluster block. For example, a set of the importance degrees of the cluster blocks and the information for specifying the objects included in the respective cluster blocks is output. The destination to which the important cluster block information is output may be a storage unit such as an HDD or a memory card. Alternatively, the important cluster block information may be distributed via a network, or displayed on a display device such as a monitor.

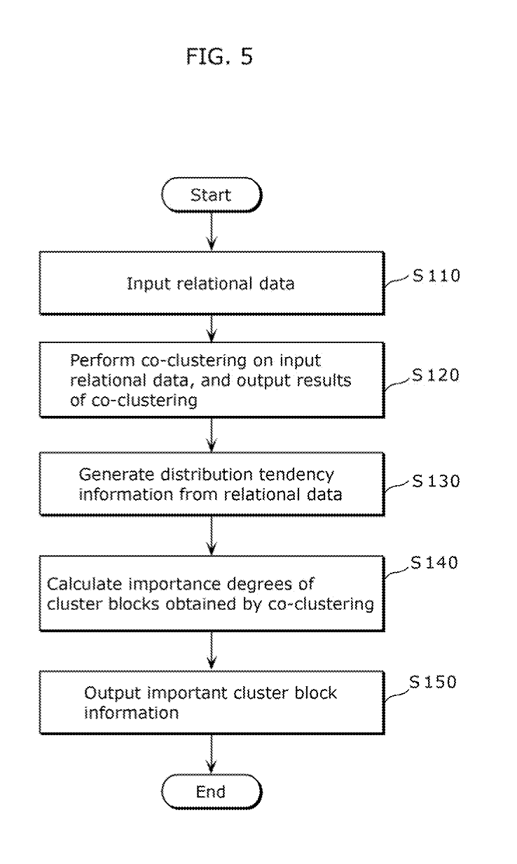

Next, an example of the operation of the co-clustering apparatus 100 according to the present embodiment will be described. FIG. 5 is a flowchart showing an example of the operation of the co-clustering apparatus 100 according to the present embodiment.

First, the data input unit 110 inputs the relational data (S110).

Next, the co-clustering unit 120 performs co-clustering on the input relational data, and outputs the result of co-clustering (S120).

Next, the distribution tendency generating unit 130 inputs the relational data, and outputs the distribution tendency information (S130).

Next, the calculating unit 140 uses the relational data, the result of co-clustering, and the distribution tendency information as the input, and outputs the importance degrees of the cluster blocks (S140).

Finally, the output unit 150 outputs the information Indicating the importance degrees of the cluster blocks (S150).

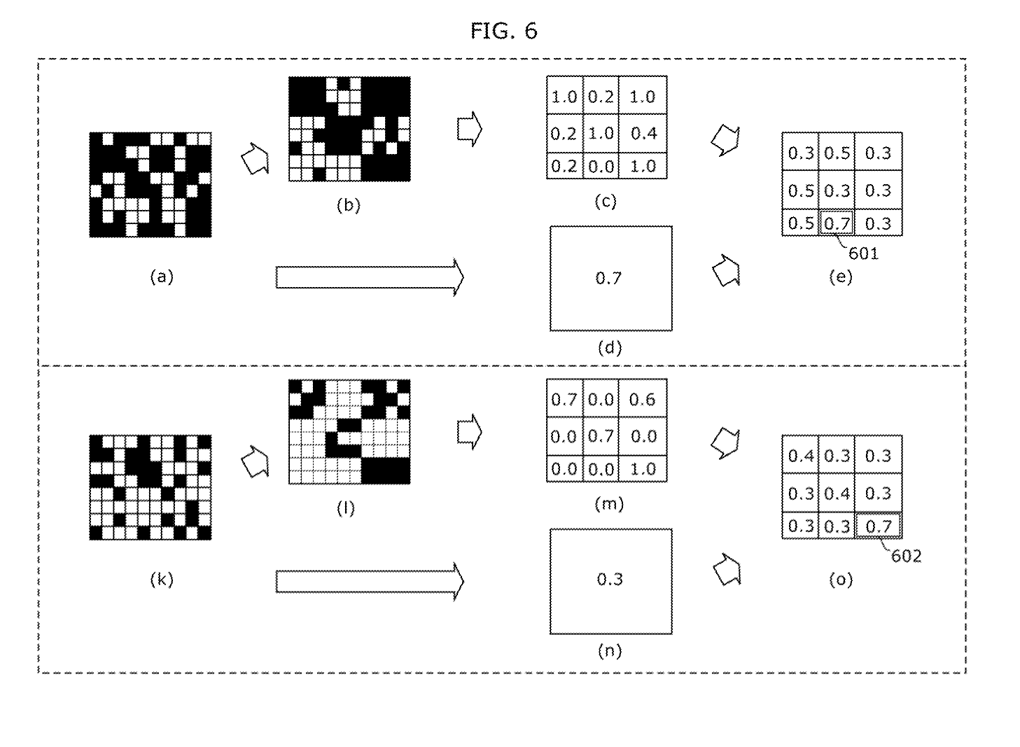

Next, an example of clustering processing performed by the co-clustering apparatus 100 will be described. FIG. 6 is a diagram showing an example of the processing performed by the co-clustering apparatus 100 according to Embodiment 1.

In FIG. 6, the processing performed by the co-clustering apparatus 100 when the statistic amount of the entire relational data is relatively large (when the input data is dense) is shown in (a) to (e). The processing performed by the co-clustering apparatus 100 when the statistic amount of the entire relational data is relatively small (when the input data is sparse) is shown in (k) to (o).

(a) of FIG. 6 is a diagram showing the relational data input by the data input unit 110 in which the statistic amount of the entire relational data is relatively large. The binary relation ({0,1}) is expressed in black and white.

(b) of FIG. 6 is the result obtained by co-clustering the relational data.

(c) of FIG. 6 is a diagram showing the statistic amounts of the respective cluster blocks in the data which are obtained by co-clustering the relational data. Here, the statistic amount of one cluster block is calculated as the proportion (filling rate) of the number of entities having a binary relation of 1 to the number of total entities in the cluster block. The statistic amounts are shown for the corresponding cluster blocks.

(d) of FIG. 6 is a diagram showing the distribution tendency of the statistic amounts of the cluster blocks shown in (c) of FIG. 6 in the entire relational data. Here, the distribution tendency of the statistic amounts of the cluster blocks in the entire relational data is calculated as the average value of the statistic amounts of the cluster blocks in the entire relational data.

(e) of FIG. 6 is a diagram showing the importance degrees of the cluster blocks. Here, the importance degree of the cluster block is calculated as the absolute value of the difference between the statistic amount of the cluster block ((c) of FIG. 6) and the statistic amount of the entire relational data ((d) of FIG. 6). (e) of FIG. 6 shows that the cluster block 601 has the greatest importance degree. Namely, when the statistic amount of the entire relational data is relatively large, a greater importance degree is calculated for the cluster block having a relatively small statistic amount.

(k) of FIG. 6 is a diagram showing the relational data input by the data input unit 110 in which the statistic amount of the entire relational data is relatively small. (l) to (o) of FIG. 6 correspond to (b) to (e) of FIG. 6, respectively.

(o) of FIG. 6 shows that the cluster block 602 has the greatest importance degree. Namely, when the statistic amount of the entire relational data is relatively small, a greater importance degree is calculated for the cluster block having a relatively large statistic amount.

As above, the co-clustering apparatus 100 calculates the importance degrees of the cluster blocks based on the statistic amount of the entire relational data, and outputs the importance degrees. The calculation method can also be expressed as change in the result of calculation of the importance degree according to the statistic amount of the entire relational data. Because the result of calculation of the importance degree changes according to the statistic amount of the entire relational data, a different importance degree will be output if the cluster blocks each have the same entities and the entire relational data has a different statistic amount.

As above, the co-clustering apparatus according to the present embodiment is a co-clustering apparatus that performs the co-clustering processing on the relational data expressible in a format of a matrix or a tensor having at least three dimensions to divide the relational data into cluster blocks. The co-clustering apparatus includes a distribution tendency generating unit configured to generate a distribution tendency of statistic amounts of the cluster blocks in the entire relational data, each of the statistic amounts indicating a tendency of relations generated in the corresponding cluster block; a calculating unit configured to calculate an importance degree for each of the cluster blocks based on the statistic amount of the cluster block and the distribution tendency generated by the distribution tendency generating unit, using a calculation method for changing a result of calculation of the importance degree according to the distribution tendency; and an output unit configured to output information indicating at least one of the cluster blocks and information indicating the importance degree calculated for the at least one of the cluster blocks by the calculating unit.

Thereby, the co-clustering apparatus outputs the importance degrees of the cluster blocks in consideration of the distribution tendency of the statistic amounts of the cluster blocks when the co-clustering processing is performed on the relational data expressed in a format of a matrix or a tensor having at least three dimensions. The importance degrees of the cluster blocks output here are results obtained in consideration of the statistic amount of the entire relational data and the statistic amounts of the cluster blocks. Accordingly, a different importance degree will be output if the cluster blocks each have the same entities and the entire relational data has a different statistic amount. Namely, use of the distribution tendency enables calculation of the importance degrees of the cluster blocks in consideration of the tendency of the entire input relational data. Thus, the importance degrees of the cluster blocks according to the property of the relational data can be specified.

The co-clustering apparatus according to the present embodiment can be used in various applications. For example, the co-clustering apparatus according to the present embodiment can be implemented as software for analyzing the relational data. Specifically, the co-clustering apparatus can be used in applications for the analysis of personal relationships on a social network service, the analysis of preferences or tendencies from the commodities purchase history in the Internet shopping or from the content viewing history in a content distribution service, or the analysis of relationships in the bio technology field, for example. Moreover, the co-clustering apparatus according to the present embodiment can be integrated into part of the system to attain services such as recommendation.

In the co-clustering apparatus 100 according to the present embodiment, the calculating unit 140 may use the information indicating the size of the cluster block to calculate the importance degree. For example, the areas of the respective cluster blocks are known from the results of co-clustering z¹ and z². When several cluster blocks exist whose importance degrees calculated by:

D( η̅_{ML}^{ALL}, η̅_{ML}(k,l)) [Math. 51]

are the same or close and the cluster blocks have a large area, the calculating unit 140 calculates and outputs a great importance degree I(k,l). Thereby, a relatively greater importance degree is given to the cluster block to which more objects belong.

In the co-clustering unit 120, the distribution tendency generating unit 130, and the calculating unit 140 according the present embodiment, the Input, the processing, and the output each are implemented as a defined independent procedure (algorithm), but these functional blocks (components) may not always be independent algorithms. For example, the IRM exemplified as the generative model of the relational data may be extended, and the configuration corresponding to the distribution tendency generating unit 130 and the calculating unit 140 may be included in the level of the generative model. The thus-configured co-clustering apparatus will be specifically described as a modification of the present embodiment.

### Modification of Embodiment 1

The modification of Embodiment 1 will be described.

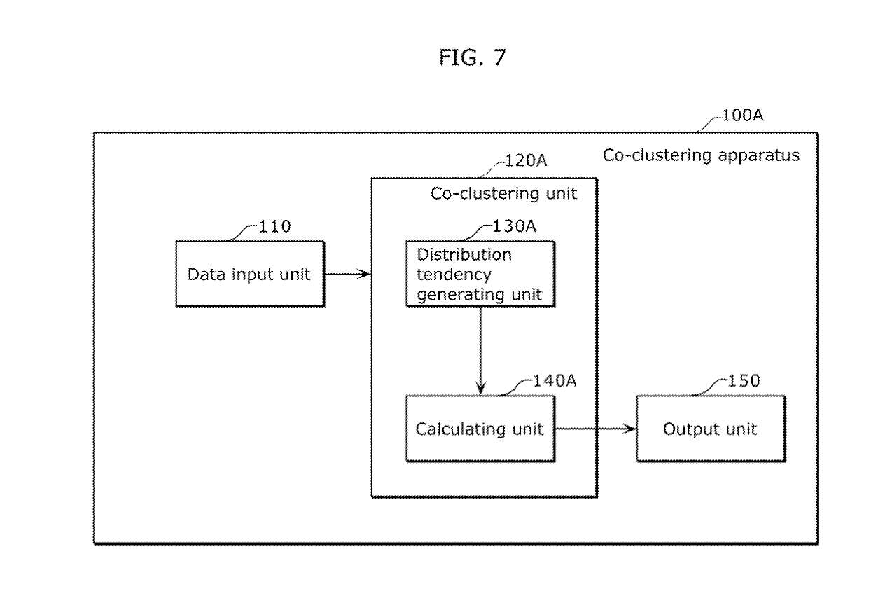

FIG. 7 is a block diagram showing a configuration of a co-clustering apparatus 100A according to the present embodiment. As shown in FIG. 7, the co-clustering apparatus 100A includes a data input unit 110, a co-clustering unit 120A, and an output unit 150. The co-clustering unit 120A has a distribution tendency generating unit 130 and a calculating unit 140 as the Internal functions.

The data input unit 110 and the output unit 150 are the same as those in the co-clustering apparatus 100, and the description thereof will be omitted.

The co-clustering unit 120A performs co-clustering on relational data R as an input, and outputs the result of co-clustering. Additionally, simultaneously with or in parallel with performing the co-clustering, the distribution tendency generating unit 130 generates the distribution tendency of the statistic amounts of the cluster blocks, and the calculating unit 140 calculates the importance degrees of the cluster blocks. Namely, the co-clustering processing and the importance degree calculation processing can be performed simultaneously or in parallel.

Specifically, for the relational data:

R:T¹×T²→{0,1}, [Math. 52]

for example, the following generative model:

[Math. 53]

zᵢ¹|γ˜CRP(γ)(iεT¹), (Expression 9-1)

zⱼ²|γ˜CRP(γ)(jεT²), (Expression 9-2)

I(k,l)|β˜Beta(β,β)(kεC¹,lεC²), (Expression 9-3)

η⁰|β˜Beta(β,β), (Expression 9-4)

η(k,l)=σ×I(k,l)+(1−σ)×η⁰(kεC¹,lεC²), (Expression 9-5)

R(i,j)|z¹,z²,η˜Bernoulli(η(zᵢ¹,zⱼ²))(iεT¹,jεT²) (Expression 9-6)

can be thought.

The generative model expressed by (Expression 9-1) to (Expression 9-6) will be briefly described. First, similarly to the IRM, cluster assignments are generated for domains (Expressions 9-1 and 9-2). The importance degree I(k,l) of the cluster block (k,l) is generated for each of the cluster blocks according to the Beta distribution (Expression 9-3). Next, the entire relational data is considered as one cluster block, and relation generation probability η⁰ over the entire relational data is generated according to the Beta distribution (Expression 9-4). Next, the relation generation probability η(k,l) unique to the cluster block is calculated from the importance degree I(k,l) of the cluster block and the relation generation probability η⁰ over the entire relational data (Expression 9-5). Here, σ is a value indicating a mixture rate, and has a predetermined value greater than 0 and not greater than 1. Finally, relations R(i,j) that form the relational data are generated according to the Bernoulli distribution in which the relation generation probability η(k,l) is a parameter (Expression 9-6).

In the generative model, the probability that the relational data R is generated is calculated by:

[Math. 54]

P(R|z¹,z²,I,η⁰,σ)P(η⁰|β)P(I|β)P(z¹|γ)P(z²|γ). (Expression 10)

Namely, as described in the IRM, use of any parameter estimation method such as Gibbs sampling and Variational Bayes Inference enables estimation of unknown parameters z¹, z², I, η⁰, and σ. Here, (Expression 9-1) and (Expression 9-2) play a role to integrate cluster assignments z¹ and z² as unknown parameters into the generative model. (Expression 9-6) shows that the relational data R is generated depending on the results of the cluster assignments z¹ and z². Namely, (Expression 9-1), (Expression 9-2), and (Expression 9-6) correspond to the co-clustering unit 120 in Embodiment 1. Additionally, focusing attention on that η⁰ is the relation generation probability over the entire relational data, η⁰ can be considered as one example of the distribution tendency information. Namely, it turns out that (Expression 9-4) corresponds to the distribution tendency generating unit 130 in the co-clustering apparatus according to Embodiment 1. Focusing attention on that (Expression 9-5) is the expression to calculate the relation generation probability η(k,l) unique to the cluster block using the importance degree I(k,l) of the cluster block and the relation generation probability over the entire relational data η⁰, (Expression 9-5) is equivalent to:

[Math. 55]

I(k,l)=1/σ×η(k,l)+(1−1/σ)×η⁰(kεC¹,lεC²). (Expression 11)

It can be considered that the expression calculates the importance degree I(k,l) of the cluster block using the relation generation probability η(k,l) unique to the cluster block and the relation generation probability over the entire relational data η⁰, and (Expression 9-5) corresponds to the calculating unit 140 in the co-clustering apparatus according to Embodiment 1.

The above description leads to a conclusion that the components that form the co-clustering apparatus 100 according to Embodiment 1 are included in (Expression 9-1) to (Expression 9-6) in the level of the generative model.

### Embodiment 2

Next, an outline of a co-clustering apparatus 200 according to Embodiment 2 will be described. In the co-clustering apparatus according to the present embodiment, the distribution tendency generating unit performs clustering processing on statistic amount data having the statistic amounts of the cluster blocks as entities to divide the statistic amount data into clusters, and generates the information on the clusters, which are obtained by the division of the statistic amount data, as the distribution tendency.

Thereby, a cluster block having a high importance degree can be specified in consideration of the distribution tendency of the statistic amounts of the cluster blocks even in the relational data having a complicated distribution tendency of the statistic amounts of the cluster blocks.

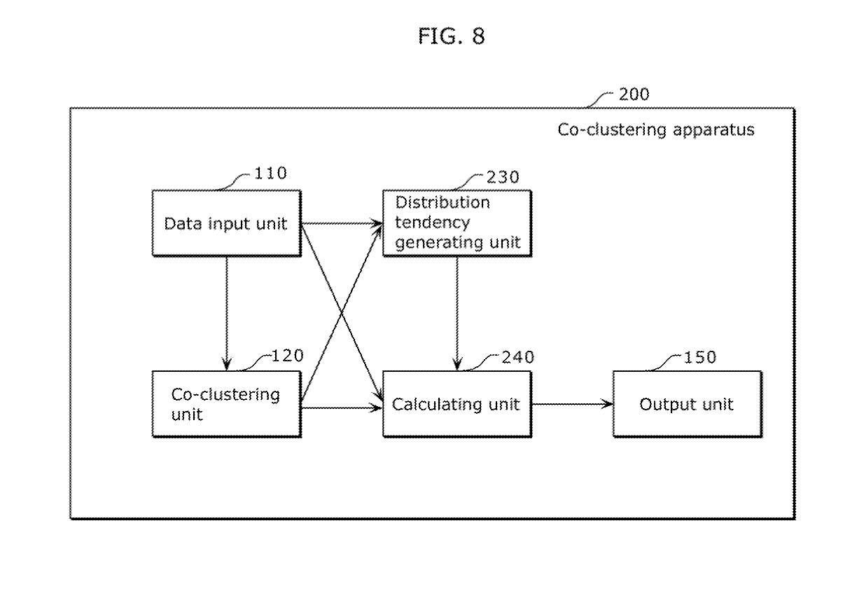

FIG. 8 is a block diagram showing an example of a configuration of the co-clustering apparatus 200 according to the present embodiment. As shown in FIG. 8, the co-clustering apparatus 200 according to the present embodiment includes a distribution tendency generating unit 230 and a calculating unit 240 instead of the distribution tendency generating unit 130 and the calculating unit 140 in the co-clustering apparatus 100 (FIG. 1). Hereinafter, differences between the co-clustering apparatus 200 and the co-clustering apparatus 100 according to the present embodiment will be described, and description of similarities will be omitted.

When the relational data R and the results of co-clustering z¹ and z² are input, among the cluster blocks, the distribution tendency generating unit 230 divides the cluster blocks into groups by clustering according to similarities of the statistic amounts that characterize the respective cluster blocks, and generates the result of grouping as the distribution tendency information. The result of grouping is the information indicating which cluster block belongs to which group. Namely, the statistic amount data composed of entities that are the statistic amounts of the cluster blocks obtained by co-clustering the relational data in Embodiment 1 is clustered to obtain the tendency of the entire relational data.

For example, similarly to the description of the co-clustering apparatus 100 according to Embodiment 1, examine an example of the binary relational data on two domains:

R:T¹×T²→{0,1}. [Math. 56]

Here, when the statistic amount that characterizes the cluster block is the average of values of relations (Expression 7), and the result of co-clustering z¹ includes K clusters and the result of co-clustering z² includes L clusters, the distribution tendency generating unit 230 clusters K×L cluster blocks into any number M (<K×L) of groups based on similarities of the statistic amounts of the cluster blocks:

η̅_{ML}(k,l). [Math. 57]

The clustering may use a famous clustering algorithm such as k-means, or may use a simple method in which a predetermined threshold is set, and the cluster blocks are grouped when the statistic amounts of the cluster blocks:

η̅_{ML}(k,l) [Math. 58]

fall within the range of the predetermined threshold. Thus, as a result of grouping, the distribution tendency generating unit 230 outputs the information indicating which one of the K×L cluster blocks belongs to which group.

The calculating unit 240 uses the result of grouping, and calculates the importance degrees for the respective cluster blocks to change the importance degrees according to the result of grouping. For example, the importance degree can be calculated to output a relatively greater value to the cluster block if the cluster block belongs to a group having a smaller number of cluster blocks in the result of grouping. Specifically, when cluster assignment of the K×L cluster blocks to the M (<K×L) groups are:

z^{CB}={z_{k,l}^{CB}}_{k=1,l=1}^{K,L}εC^{CB}{=1,2, . . . ,M}, [Math. 59]

the number Δ(k,l) of cluster blocks that belong to the same group corresponding to the cluster blocks (k,l) can be calculated by (Expression 12):

$$\begin{matrix}[ Math . 60 ] & \\ Δ ( k , l ) = {\sum }_{s = 1}^{K} {\sum }_{t = 1}^{L} δ ( {z}_{s , t}^{CB} = {z}_{k , l}^{CB} ) ( k ∈ {C}^{1} , l ∈ {C}^{2} ) . & ( Expression 12 )\end{matrix}$$

In (Expression 12), δ(•) is a function to return 1 when the result of evaluation of the expression within the brackets is true, and return 0 when the result is false. Then, the importance degree I(k,l) of the cluster block is calculated by (Expression 13):

$$\begin{matrix}[ Math . 61 ] & \\ I ( k , l ) = \frac{1}{Δ ( k , l )} ( k ∈ {C}^{1} , l ∈ {C}^{2} ) . & ( Expression 13 )\end{matrix}$$

By calculating the importance degree by (Expression 13), the importance degree I(k,l) of the cluster block has a greater value as the number of cluster blocks having the statistic amount:

η̅_{ML}(k,l) [Math. 62]

similar to the statistic amount of the cluster block is smaller. Namely, the importance degree is relatively greater as the cluster block is rarer. The importance degrees of the cluster blocks thus calculated can specify a rare and important cluster block even for the complicated relational data that cannot be expressed as in the case of the co-clustering apparatus 100 according to Embodiment 1, that is, even when the distribution tendency information cannot be expressed by the only one statistic amount:

η̅_{ML}^{ALL}. [Math. 63]

As above, in the co-clustering apparatus according to the present embodiment, the distribution tendency generating unit performs the clustering processing on the statistic amount data having the statistic amounts of the cluster blocks as entities to divide the statistic amount data into clusters, and generates the information on the clusters, which are obtained by the division of the statistic amount data, as the distribution tendency.

Thereby, a cluster block having a high importance degree can be specified in consideration of the distribution tendency of the statistic amounts of the cluster blocks even in the relational data having a complicated distribution tendency of the statistic amounts of the cluster blocks.

The co-clustering apparatus according to the present embodiment can be used in various applications. As a most basic example, the co-clustering apparatus according to the present embodiment can be implemented as software for analyzing the relational data. Specifically, the co-clustering apparatus can be used in applications for the analysis of personal relationships on a social network service, the analysis of preferences or tendencies from the commodities purchase history in the Internet shopping or from the content viewing history in a content distribution service, or the analysis of relationships in the bio technology field, for example. Moreover, the co-clustering apparatus according to the present embodiment can be integrated into part of the system to attain services such as recommendation.

In the co-clustering apparatus 200 according to the present embodiment, the calculating unit 240 may use the information indicating the size of the cluster block to calculate the importance degree. For example, the areas of the respective cluster blocks are known from the results of co-clustering z¹ and z^{Z}. When several cluster blocks exist wherein

I/Δ(k,l) [Math. 64]

are the same or close, the importance degree I(k,l) is calculated by the expression obtained by correcting (Expression 13) to output a greater importance degree I(k,l) as the sum of the areas of the cluster blocks that belong to the same group is greater. Thereby, a group to which the cluster blocks having large areas belong has a relatively greater importance degree.

In the co-clustering unit 120, the distribution tendency generating unit 230, and the calculating unit 240 according to the present embodiment, the input, the processing, and the output each are implemented as a defined independent procedure (algorithm), but these functional blocks (components) may not always be independent algorithms.

For example, the IRM exemplified as the generative model of the relational data may be extended, and the configuration corresponding to the distribution tendency generating unit 230 or the calculating unit 240 may be partially or entirely included in the level of the generative model.

Specifically, for the relational data:

R:T¹>T²→{0,1}, [Math. 65]

for example, the generative model including the distribution tendency generating unit:

### [Math. 66]

zᵢ¹|γ˜CRP(γ)(iεT¹), (Expression 14-1)

zⱼ²|γ˜CRP(γ)(jεT²), (Expression 14-2)

z_{k,l}^{CB}|z¹,z²˜CRP(γ)(kεC¹,lεC²), (Expression 14-3)

θᵤ|β˜Beta(β,β)(uεC^{CB}), (Expression 14-4)

η(k,l)=θz^{CB}(zᵢ¹,zⱼ²)(kεC¹,lεC²) (Expression 14-5)

R(i,j)|z¹,z²,η˜Bernoulli(η(zᵢ¹,zⱼ²))(iεT¹,jεT²) (Expression 14-6)

can be thought.

The generative model expressed by (Expression 14-1) to (Expression 14-6) will be briefly described. First, similarly to the IRM, cluster assignments are generated for domains (Expression 14-1 and 14-2). Next, the result z^{CB} of grouping the cluster blocks (k,l) is generated (Expression 14-3). Next, relation generation probability θᵤ unique to the group u of the cluster blocks is generated (Expression 14-4). Next, for each of the cluster blocks, the relation generation probability η(k,l) of the cluster block is selected from θ depending on the group to which the cluster block belongs:

z_{k,l}^{CB} [Math. 67]

(Expression 14-5). Finally, relations R(i,j) that form the relational data are generated according to the Bernoulli distribution wherein the relation generation probability r(k,l) is a parameter (Expression 14-6).

In the generative model, the probability that the relational data R is generated is calculated by:

[Math. 68]

P(R|z¹,z²,η)P(θ|β)P(z^{CB}|γ)P(z¹|γ)P(z²|γ). (Expression 15)

Namely, as described in the IRM, use of any parameter estimation method such as Gibbs sampling or Variational Bayes Inference enables estimation of unknown parameters z¹, z², z^{CB}, and η. Here, (Expression 14-1) and (Expression 14-2) play a role to integrate the cluster assignments z¹ and z² as unknown parameters into the generative model. (Expression 14-6) shows that the relational data R is generated depending on the results of cluster assignments z¹ and z². Namely, (Expression 9-1), (Expression 9-2), and (Expression 9-6) correspond to the co-clustering unit 120 in Embodiment 2. z^{CB} represents clustering of K×L cluster blocks specified by the cluster assignments z¹ and z² into the M (<K×L) groups, and can be considered as one example of the distribution tendency information. Namely, it turns out that (Expression 14-4) corresponds to the distribution tendency generating unit 230 in the co-clustering apparatus according to Embodiment 2. The estimation of unknown parameters by the model described above can simultaneously provide the results of co-clustering z¹ and z² as the output from the co-clustering unit 120 and the distribution tendency information z^{CB} as the output from the distribution tendency generating unit 230. When z¹, z², and z^{CB} are obtained, (Expression 12) and (Expression 13) can also be used to calculate the importance degree.

The above description leads to a conclusion that the components that form the co-clustering apparatus 200 according to the present embodiment are included in (Expression 14-1) to (Expression 14-6) in the level of the generative model.

### Other Modification

The co-clustering apparatuses according to the embodiments described above are typically implemented as an LSI as a semiconductor integrated circuit. The components of the co-clustering apparatuses each may be implemented as a single chip, or the components of the co-clustering apparatus may be partially or entirely implemented as a single chip. Here, the semiconductor integrated circuit is referred to as the LSI, but may be referred to as an IC, a system LSI, a super LSI, or an ultra LSI depending on the difference in the integration density.

Instead of the use of the LST for the integration of the components, a dedicated circuit or a general purpose processor may be used for the integration. The integration may be implemented with the Field Programmable Gate Array (FPGA) which is programmable after building the LSI or the reconfigurable processor which allows a circuit cell in the LSI to be reconnected and reconfigured.

In the case where the advancement of the semiconductor technology or another derivative technology thereof introduces and a new circuit integrating technique which will replace the LSI, the new technology may be employed as a matter of course to integrate the functional blocks. Examples thereof may include application of biotechnology.

Additionally, a drawing apparatus adapted to various applications can be configured with a combination of a semiconductor chip manufactured by integrating the co-clustering apparatus according the present embodiment and a display for drawing an image. Such a co-clustering apparatus can be used as an information drawing unit for mobile phones, televisions, digital video recorders, digital video cameras, and car navigation systems, for example. Examples of the display used in combination include cathode-ray tube (CRT) displays; flat panel displays such as liquid crystal displays, plasma display panel (PDP) displays, and organic EL displays; and projection displays such as projectors.

In the embodiments described above, the components each may be implemented with dedicated hardware (electronic circuit), or may be implemented by executing a software program suitable for the component. Alternatively, the components each may be implemented by a program executing unit such as a CPU or processor that reads a software program recorded on a recording medium such as a hard disk or a semiconductor memory and executes the program. Here, non-limiting examples of the software that implements the co-clustering apparatuses according to the embodiments include the following program.

Namely, the program causes a computer to execute a co-clustering method in a co-clustering apparatus that performs co-clustering processing on relational data expressible in a format of a matrix or a tensor having at least three dimensions to divide the relational data into cluster blocks, the method comprising: generating a distribution tendency of statistic amounts of the cluster blocks in the entire relational data, each of the statistic amounts indicating a tendency of relations generated in the corresponding cluster block; calculating an importance degree for each of the cluster blocks based on the statistic amount of the cluster block and the distribution tendency generated by the distribution tendency generation, using a calculation method for changing a result of calculation of the importance degree according to the distribution tendency; and outputting information indicating at least one of the cluster blocks and information indicating the importance degree calculated for the at least one of the cluster blocks by the calculation.

As above, the co-clustering apparatuses according to one or more aspects have been described based on the embodiments, but the herein disclosed subject matter will not be limited to the embodiments. The herein disclosed subject matter is to be considered descriptive and illustrative only, and the appended Claims are of a scope intended to cover and encompass not only the particular embodiments disclosed, but also equivalent structures, methods, and/or uses.

### INDUSTRIAL APPLICABILITY

One or more exemplary embodiments disclosed herein are applicable to various applications. For example, these are highly useful as a menu display in mobile phones, portable music players, and portable display terminals such as digital cameras and digital video cameras; a menu in high resolution information display apparatuses such as televisions, digital video recorders, and car navigation systems; or an information displaying method in Web browsers, editors, EPGs, and map displays.

1. A co-clustering apparatus that performs co-clustering processing on relational data expressible in a format of a matrix or a tensor having at least three dimensions to divide the relational data into cluster blocks, the co-clustering apparatus comprising:
a distribution tendency generating-unit configured to generate a distribution tendency of statistic amounts of the cluster blocks in the entire relational data, each of the statistic amounts indicating a tendency of relations generated in the corresponding cluster block;
a calculating unit configured to calculate an importance degree for each of the cluster blocks based on the statistic amount of the cluster block and the distribution tendency generated by the distribution tendency generating unit, using a calculation method for changing a result of calculation of the importance degree according to the distribution tendency; and
an output unit configured to output information indicating at least one of the cluster blocks and information indicating the importance degree calculated for the at least one of the cluster blocks by the calculating unit.

2. The co-clustering apparatus according to claim 1,
wherein the distribution tendency generating unit is configured to generate a statistic amount of the entire relational data as the distribution tendency.

3. The co-clustering apparatus according to claim 2,
wherein the calculating unit is configured to calculate the importance degree for each of the cluster blocks to output a greater importance degree as a distance between a value in the cluster block indicated by the distribution tendency and the statistic amount of the cluster block is larger.

4. The co-clustering apparatus according to claim 2,
wherein the calculating unit is configured to calculate the importance degree for each of the cluster blocks using the distribution tendency, the statistic amount of the cluster block, and a size of the cluster block.

5. The co-clustering apparatus according to claim 1,
wherein the distribution tendency generating unit is configured to perform clustering processing on statistic amount data having the statistic amounts of the cluster blocks as entities to divide the statistic amount data into clusters, and generate information on the clusters as the distribution tendency, the clusters being obtained by the division of the statistic amount data.

6. The co-clustering apparatus according to claim 5,
wherein the calculating unit is configured to calculate the importance degree for each of the clusters to output a greater importance degree for the cluster block included as an entity in the cluster as the number of entities within the cluster is smaller.

7. The co-clustering apparatus according to claim 5,
wherein the calculating unit is configured to calculate the importance degree for each of the cluster blocks included as entities in the cluster, based on the number of entities within the cluster and sizes of one or more of the cluster blocks corresponding to entities of the clusters for each of the clusters.

8. A co-clustering method in a co-clustering apparatus that performs co-clustering processing on relational data expressible in a format of a matrix or a tensor having at least three dimensions to divide the relational data into cluster blocks, the co-clustering method comprising:
generating a distribution tendency of statistic amounts of the cluster blocks in the entire relational data, each of the statistic amounts indicating a tendency of relations generated in the corresponding cluster block;
calculating an importance degree for each of the cluster blocks based on the statistic amount of the cluster block and the distribution tendency generated by the distribution tendency generation, using a calculation method for changing a result of calculation of the importance degree according to the distribution tendency; and
outputting information indicating at least one of the cluster blocks and information indicating the importance degree calculated for the at least one of the cluster blocks by the calculation.

9. A non-temporary computer-readable recording medium on which a program causes a computer to execute the co-clustering method according to claim 8 is recorded.

10. An integrated circuit that performs co-clustering processing on relational data expressible in a format of a matrix or a tensor having at least three dimensions to divide the relational data into cluster blocks, the integrated circuit comprising:
a distribution tendency generating unit configured to generate a distribution tendency of statistic amounts of the cluster blocks in the entire relational data, each of the statistic amounts indicating a tendency of relations generated in the corresponding cluster block;
a calculating unit configured to calculate an importance degree for each of the cluster blocks based on the statistic amount of the cluster block and the distribution tendency generated by the distribution tendency generating unit, using a calculation method for changing a result of calculation of the importance degree according to the distribution tendency; and
an output unit configured to output information indicating at least one of the cluster blocks and information indicating the importance degree calculated for the at least one of the cluster blocks by the calculating unit.
